(19) United States
(12) Patent Application Publication
(10) Pub. No.: US 2015/0170074 A1
(43) Pub. Date: Jun. 18, 2015

(54) DYNAMIC AND ADAPTABLE EVENT INTEGRATION FOR FLEXIBLE BUSINESS PROCESSES

(71) Applicants: Matthias Winkler, Dresden (DE); Theo Dirk Meijler, Dresden (DE)

(72) Inventors: Matthias Winkler, Dresden (DE); Theo Dirk Meijler, Dresden (DE)

(21) Appl. No.: 14/106,432

(22) Filed: Dec. 13, 2013

(51) Int. Cl. G06Q 10/06

(52) U.S. Cl. CPC G06Q 10/0633

(57) ABSTRACT

A message middleware may include an action item subscription handler to register an action item subscription for each of a plurality of business partners, each action item subscription corresponding to a business message handler that is compatible with an event registration system of a corresponding business partner. The message middleware also may include a plurality of business message handlers to facilitate execution of a process instance of business process model, including execution of task instances of the plurality of ordered tasks, wherein a role of each task instance is mapped to a business partner of the plurality of business partners. The message middleware may also provide, during a task instance execution, an action item of the executing task instance to a corresponding business partner, using a corresponding business message handler identified by a corresponding action item subscription.

### TECHNICAL FIELD

This description relates to business process modeling.

### BACKGROUND

Many types of software have been developed with the purpose of providing users with an ability to design and execute business processes. Specifically, such software generally facilitates the representation of a business process using a business process model, in which individual tasks of the business process are represented as connected nodes within a directed graph, and in which directed edges connecting the various task nodes govern an order of execution of the underlying tasks.

The use of such business process models in executing underlying business processes provides increased efficiency, customer satisfaction, and overall profitability of an associated business. For example, once a business process model has been designed and tested, the business process model represents a readily-available, trusted resource for governing associated business operations in an optimized manner.

Also advantageously, such business process models may be implemented in a flexible and/or collaborative fashion. For example, business process models may be designed flexibly, so that execution details of individual tasks of the business process model are not decided or selected until actual execution of the associated task has begun, or is about to begin. Additionally, or alternatively, business process models may be implemented in a collaborative fashion, so that individual tasks of the business process model may implement communication with external business partners for a successful execution.

In the latter scenarios, it may be difficult (from a technical perspective) for individual business partners to create a communications channel between a business process model(s) and individual business partners. Moreover, since the business process model may be flexibly designed to communicate with a potentially large number of available business partners, such communication difficulties may be enhanced. Consequently, businesses may be restricted from fully realizing available capabilities of business process models, and/or from collaborating with a full range of otherwise-available business partners.

### SUMMARY

According to one general aspect, a system includes instructions recorded on a non-transitory computer-readable medium, and executable by at least one semiconductor processor. The system includes a message middleware configured to cause the at least one semiconductor processor to determine a business process model that includes a plurality of ordered tasks, the ordered tasks each associated with at least one role and at least one action item. The message middleware further includes an action item subscription handler configured to cause the at least one semiconductor processor to register an action item subscription for each of a plurality of business partners, each action item subscription corresponding to a business message handler that is compatible with an event registration system of a corresponding business partner. The message middleware further includes a plurality of business message handlers configured to facilitate execution of a process instance of the business process model, including execution of task instances of the plurality of ordered tasks, wherein each role of each task instance is mapped to a business partner of the plurality of business partners. The message middleware is further configured to cause the at least one semiconductor processor to provide, during a task instance execution, the at least one action item of the executing task instance to a corresponding business partner, using a corresponding business message handler identified by a corresponding action item subscription.

According to another general aspect, a computer-implemented method for executing instructions stored on a non-transitory computer readable storage medium includes determining a business process model that includes a plurality of ordered tasks, the ordered tasks each associated with at least one role and at least one action item, and registering an action item subscription for each of a plurality of business partners, each action item subscription corresponding to a business message handler that is compatible with an event registration system of a corresponding business partner. The computer-implemented method further includes facilitating execution of a process instance of the business process model, including execution of task instances of the plurality of ordered tasks, wherein each role of each task instance is mapped to a business partner of the plurality of business partners, and providing, during a task instance execution, the at least one action item of the executing task instance to a corresponding business partner, using a corresponding business message handler identified by a corresponding action item subscription.

According to another general aspect, a computer program product tangibly embodied on a non-transitory computer-readable storage medium comprises instructions that, when executed, are configured to determine a business process model that includes a plurality of ordered tasks, the ordered tasks each associated with at least one role and at least one action item, and register an action item subscription for each of a plurality of business partners, each action item subscription corresponding to a business message handler that is compatible with an event registration system of a corresponding business partner. The instructions, when executed, are further configured to facilitate execution of a process instance of the business process model, including execution of task instances of the plurality of ordered tasks, wherein each role of each task instance is mapped to a business partner of the plurality of business partners, and provide, during a task instance execution, the at least one action item of the executing task instance to a corresponding business partner, using a corresponding business message handler identified by a corresponding action item subscription.

The details of one or more implementations are set forth in the accompanying drawings and the description below. Other features will be apparent from the description and drawings, and from the claims.

### BRIEF DESCRIPTION OF THE DRAWINGS

FIG. 1A is a block diagram of a system for dynamic and adaptable event integration for flexible business processes.

FIG. 1B is a block diagram of a more detailed example implementation of the message middleware of FIG. 1A.

FIG. 2 is a flowchart illustrating example operations of the systems of FIGS. 1A, 1B.

FIG. 3 is a block diagram of an implementation of the systems of FIGS. 1A, 1B.

FIG. 4 is a block diagram illustrating example operations of the example implementation of FIG. 3.

FIG. 5 is a flowchart illustrating detailed example operations of the systems of FIGS. 3 and 4.

### DETAILED DESCRIPTION

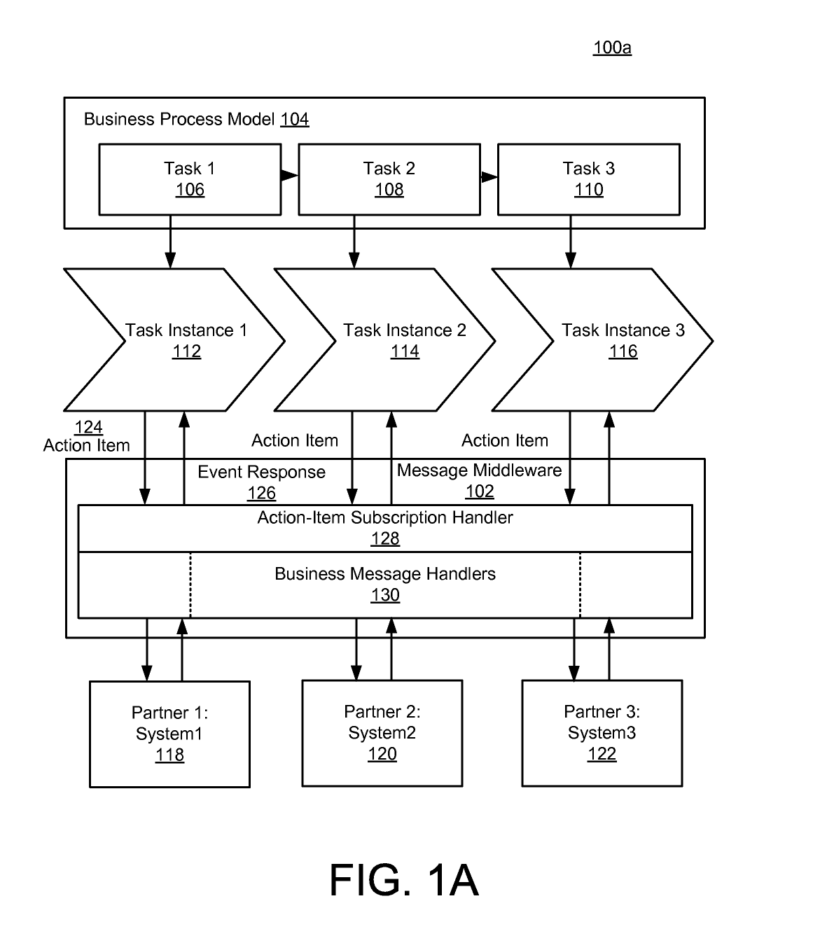

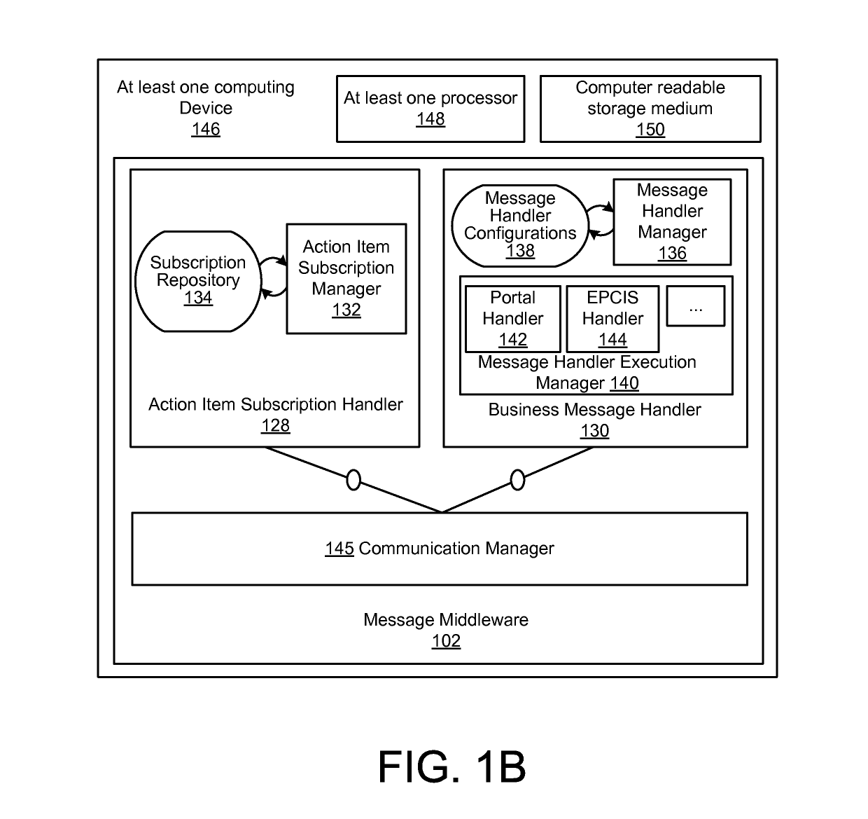

FIG. 1A is a block diagram of a system 100a for dynamic and adaptable event integration for flexible business processes. In the example of FIG. 1A, message middleware 102 is configured to facilitate execution of a business process model 104, illustrated as including example tasks 106, 108, 110. More specifically, as described in detail below, the message middleware 102 may be configured to facilitate interactions between individual task instances 112, 114, 116 of corresponding, respective tasks 106, 108, 110, with respect to interactions between the task instances 112, 114, 116 and one or more business partners, illustrated in FIG. 1A as partner 118, partner 120, and partner 122. By facilitating interactions between the task instances 112, 114, 116 and one or more of the business partners 118, 120, 122, the message middleware 102 ensures that the task instances 112, 114, 116 may be executed using an appropriate one (or more) of the available business partners 118, 120, 122, without regard for technical capabilities and/or operational preferences of the business partners 118, 120, 122.

In more detail, and as referenced above, the business process model 104 may represent virtually any business process represented in software as a plurality of ordered task nodes connected by directed edges. In the example of FIG. 1A, the business process model 104 is illustrated, for the sake of simplicity, as a sequentially-ordered series of tasks 106, 108, 110. Of course, in various implementations, the business process model 104 may represent a highly detailed, complex, large set of ordered tasks, in which, for example, the ordered tasks may be arranged in parallel, nested, looped, iterative, and/or branched fashion.

Moreover, as described and illustrated, at least some tasks of the business process model 104 may be designed for implementation and collaboration with one or more business partners (e.g., business partners 118, 120, 122). Further, such collaborations may be designed to be short-term, rather than long-term, collaborations. Also, such collaborations may be designed to be flexible. For example, a finalized process flow of the business process model 104 may be determined only during an actual execution or runtime of corresponding task instances 112, 114, 116, rather than during a design time of the underlying business process model 104. For example, as described in more detail below, in an example in which the business process model 104 relates to a transportation process involving several carriers, each carrier executing one or more of a plurality of transportation segments, a number of transportation segments and/or selected carriers may vary for each instance of the transportation process of the business process model 104.

In this regard, in the simplified example of FIG. 1A, the task instances 112, 114, 116 correspond to individual instantiations of corresponding, respected tasks 106, 108, 112. Again, just as described above with respect to the business process model 104, it may be appreciated that the task instances 112, 114, 116 represent highly simplified examples of instantiations of the underlying tasks 106, 108, 110, for the sake of explanation and example. In practice, many different instantiations of the business process model 104 may be created and executed, perhaps partially or completely in parallel with one another. Moreover, in such instantiations, it is not necessary or required that there be a one-to-one correspondence between tasks of the business process model 104 and any particular instantiation thereof. For example, not all tasks of the business process model 104 need be instantiated within a given instance, and, conversely, it may occur that a single task of the business process model 104 is instantiated multiple times for parallel execution of an associated task. All such instantiations will be assumed to reflect or otherwise correspond to the existing structure of the underlying business process model 104, and to be executed using a business process execution engine or workflow engine (not illustrated in FIG. 1A).

With respect to a collaborative nature of executions of the business process model 104, e.g., executions of the task instances 112, 114, 116, it may be appreciated that the business process model 104 may be designed for implementation by a particular business entity (e.g., a company, organization, or enterprise). This business entity is assumed, for the sake of example, to own the business process model 104, and to have responsibility for the instantiation and execution of individual instances thereof.

For example, a given task of the business process model 104 may be associated with one or more roles within the business entity, so that corresponding task instances of such a task may be mapped for execution thereof to an individual employee(s) of the business entity who correspond(s) to the associated role(s). For example, a task of the business process model 104 may be associated with the role of “manager” or “administrator,” so that instances of such a task may be mapped for execution by individual employees who are assigned to the designated role (s). In this way, the various task instances may be executed, either automatically, semi-automatically, or manually, and information regarding such executions of task instances (e.g., regarding a beginning, completion, or exception) may be shared among appropriate parties within the business enterprise.

Analogously, as referenced herein, roles associated with tasks of the business process model 104 may be mapped to individual business partners operating outside of the business entity which owns the business process model 104, and communicating with individual task instances of the business process model 104 by way of the message middleware 102. For example, a task of the business process model 104, such as the task 106, may be associated with a role of “shipper,” so that the corresponding task instance 112 may be associated with a mapping of the role “shipper” to an individual business partner which provides shipping services, such as, e.g., the business partner 110.

Further, it may be appreciated that such a mapping of the role of “shipper” may be completed differently for different instances of the task 106. In other words, different instances of the task 106 may utilize different “shippers,” for the same or different shipping services provided by the business partner 118 in the example just referenced (For example, a different “shipper” may be used to provide transportation for shipments between the same or different locations, or with a same or different shipping speed or other shipping characteristic). Similarly, as also illustrated in the example of FIG. 1A, remaining task instances 114, 116 may require collaboration with corresponding, respective partner systems 120, 122, with the similar understanding that different business partners may be desired for collaboration in the context of different task instances of the same underlying tasks of the business process model 104.

Unlike scenarios referenced above in which instance executions occur within the business entity owning the business process model 104, communication and collaborations with external business partners, such as the business partners 118, 120, 122, may be subject to widely varying communication protocols and techniques. Moreover, such variations may change over time, or may change based on context changes associated with individual executions of specific task instances. Additionally, such variations in communication policies and procedures may occur in conjunction with additions, or replacements, of existing business partners.

Thus, it may be appreciated from the above description that a purpose of the collaboration between the task instances 112, 114, 116 and the business partners 118, 120, 122, is to leverage capabilities of the business partners 118, 120, 122 for purposes of executing at least one aspect of each of the corresponding task instances 112, 114, 116. In other words, it is necessary for each task instance to communicate with a corresponding business partner in order to express a desired action to be performed by the business partner, for the business partner to execute the desired action using locally-available resources and capabilities, and for the business partner to communicate one or more events associated with a start, status, exception, or completion of the requested action.

Therefore, as shown in FIG. 1A with respect to the specific example of the task instance 112 and the business partner 118, the task instance 112 may generate and send one or more action items, illustrated as action item 124, by way of the message middleware 102, to the business partner 118. As just referenced, the business partner 118 may proceed to commence execution of the requested action specified by the action item 124, and, in response, may send one or more event responses 126 back to the task instance 112, to thereby report regarding the requested action.

Advantageously, by processing the action item 124 and the event response 126 as described in detail below, the message middleware 102 enables process-based event registration, in which the business process (e.g., the task instance 112 of the business process model 104) may determine which events are required, even when the business process is ad hoc, so that in such cases, it is not necessarily known at design time what events will be needed by the task instance 112. In this way, a collaborative business process such as that modeled by the business process model 104 may be configured to be highly adaptable, so that required events may be identified at runtime, and changes or other adaptations of the process flow may be made, based on the received event response.

Further, as also described herein, the message middleware 102 enables a decoupling of the action item 124, which signals a specified need for a required process-based event registration, from a manner in which the required event registration is executed by the corresponding business partner 118. That is, the message middleware decouples the action item 124 from partner-specific techniques and infrastructure utilized by the business partner 118 to produce the event response 126.

Thus, the message middleware 102 of FIG. 1A provides for ad hoc process-based event registration in a collaborative setting, in which different business partners (e.g., the business partners 118, 120, 122) each may have different technical techniques for executing such event registrations. In order to provide these and other related advantages and functionalities, the message middleware 102 includes an action item subscription handler 128, and a plurality of business message handlers 130. More specifically, the action item subscription handler 128 may be configured to route action items and event responses, such as the action 124 and the event response 126, to an appropriate business message handler of the plurality of business message handlers 130. The specified business message handler identified by the action item subscription handler 128 for collaboration with a corresponding business partner is configured to serve as a message exchange and translator for providing action items to the associated business partner, and for providing events received from the same business partner back to the originally-requesting task instance. In this way, the message middleware 102 provides for flexible, convenient, and transparent communications between any given task instance and any business partner registered with a corresponding business message handler and associated therewith by the action item subscription handler 128.

Continuing the above example from the logistics domain, in which the business process model 104 relates at least partially to a transportation of goods realized by multiple transport legs, it may occur that one such transport leg represents the transport of goods from one location to another location by a specified shipper or carrier, (e.g., the transportation of goods from a factory to a warehouse via truck, or from a first harbor to a second harbor via ship). In such examples, the selection of individual transport legs, as well as corresponding selections of business partners for execution of the specified transportation, may be flexible. That is, for example, while the business process model 104 may clearly define and require shipment of specified goods from one location to another, the selected transport legs and business partners may be defined and configured during an actual execution (i.e., instance) of the business process model 104.

In such examples, as described above, action items (such as the action item 124) for corresponding business partners may be triggered during a given execution of the business process model 104. For example, in the specific example, the action item 124 may represent a need of the task instance 112 to be notified when the carrier of the transport leg (e.g., the business partner 118) begins and/or finishes the requested transportation. Consequently, in the example, the event 126 would represent such notifications related to the requested transportation leg, as sent by the carrier (i.e., the business partner 118) to the task instance 112.

Thus, it may be appreciated that the business partner 118 must be identified as the correct business partner to receive the action item 124. Further, it may be required to define specific techniques used by the identified business partner 118 to execute or detect the required events, as well as to provide notifications of the events back to the task instance 112 upon occurrence thereof.

As described, each collaborating business partner may implement a different infrastructure for detecting, triggering, and/or handling real world events. For example, a simple approach may include the usage of a button of a user interface. In a specific type of example, the action item 124 may trigger a user interface to display a corresponding button or other graphical element, and, similarly, detection of a real world event may cause a similar button or graphical element to be provided in the context of a same or related user interface. In other examples, a business partner may utilize a container tracking system, such as in the types of logistic scenarios referenced above. For example, radio frequency ID (RFID) tags may be detected by corresponding scanners, which may provide event notifications in the context of a hardware/software platform of a particular business partner. Many other types of event infrastructures may be implemented, some of which are referenced in more detail, below.

FIG. 1B is a block diagram of a more detailed example implementation of the message middleware 102 of FIG. 1A. As described above, the action item subscription handler 128 may be configured to manage partner subscriptions to current and future action items, such as the action item 124. As illustrated in the example of FIG. 1B, the various business partners, e.g., the business partners 118, 120, 122, may be provided with an ability to specify action items which are of interest, and thereby indicate which business message handler of the business message handlers 130 should be used to mediate exchange of future action items received from event instances and events returned to the process instance from the business partner in question.

Thus, as shown in FIG. 1B, an action item subscription manager 132 may be configured to provide an interface (e.g., user interface, graphical user interface, application program interface, web service interface, etc.) to authorized business partners, with which the authorized business partners may set up, configure, change, and/or delete action item subscriptions. The action item subscription manager 132 also may be configured to provide functionality for determining a recipient of an action item. Specifically, as shown, a subscription repository 134 may be configured to store all active subscriptions for action items, for each of the plurality of subscribing business partners.

Further in FIG. 1B, business message handlers 130 of FIG. 1A are illustrated in further detail. As referenced above, the business message handlers 130 allow business partners and/or administrators of the message middleware 102 to configure message handling capabilities required or preferred by the business partner in question, with respect to future interactions with the underlying process instances of the business process model 104. For example, in some implementations, the business partner may interact only with the action item subscription handler 128, so that corresponding configuration changes with respect to one or more corresponding business message handlers 130 may be executed by an administrator of the message middleware 102. In additional or alternative implementations, the business partner may be provided with some ability to provide direct configuration of a specified and desired business message handler.

In the example of FIG. 1B, the business message handlers 130 are illustrated as including a message handler manager 136, which may be utilized to create, configure, delete, or otherwise manage various message handler configurations stored within a message handler configuration repository 138. That is, in the message handler configuration repository 138, all current user configurations for corresponding message handlers may be stored, to thereby be made available for future message handler execution processes.

In order to execute actual mediation and translation of action items and corresponding event responses, a message handler execution manager 140 may be configured to execute individual message handlers, e.g., a portal handler 142, or an EPCIS (Electronic Product Code Information Services) handler, as described in more detail below. In other words, the individual handlers 142, 144 may be responsible for executing actual message exchanges between process instances and individual business partners, in accordance with a corresponding message handler configuration from the message handler configuration repository 138, and based on a corresponding action item subscription, as managed by the action item subscription handler 128.

In the example of FIG. 1B, the business message handlers 130 are referred to in the plural form, reflecting the fact that a number of business message handlers may be implemented and utilized within the message middleware 102. For example, it may occur that an individual business message handler is implemented that includes all of the components 136, 138, 140 illustrated in the example of FIG. 1B.

In other implementations, however, it may occur that portions of the components 136, 138, 140 of FIG. 1B may be common to a plurality of business message handlers, and therefore may be shared among the plurality of business message handlers. For example, the message handler configuration repository 138 may be configured to store a plurality of message handler configurations that are shared by different message handlers. Moreover, it may occur that a single message handler may be shared by two or more business partners, in situations where the business partners have identical or sufficiently overlapping requirements for message exchange. In other example implementations, however, it may occur that business message handlers, or portions thereof, are maintained in a one-to-one correspondence with corresponding, individual business partners.

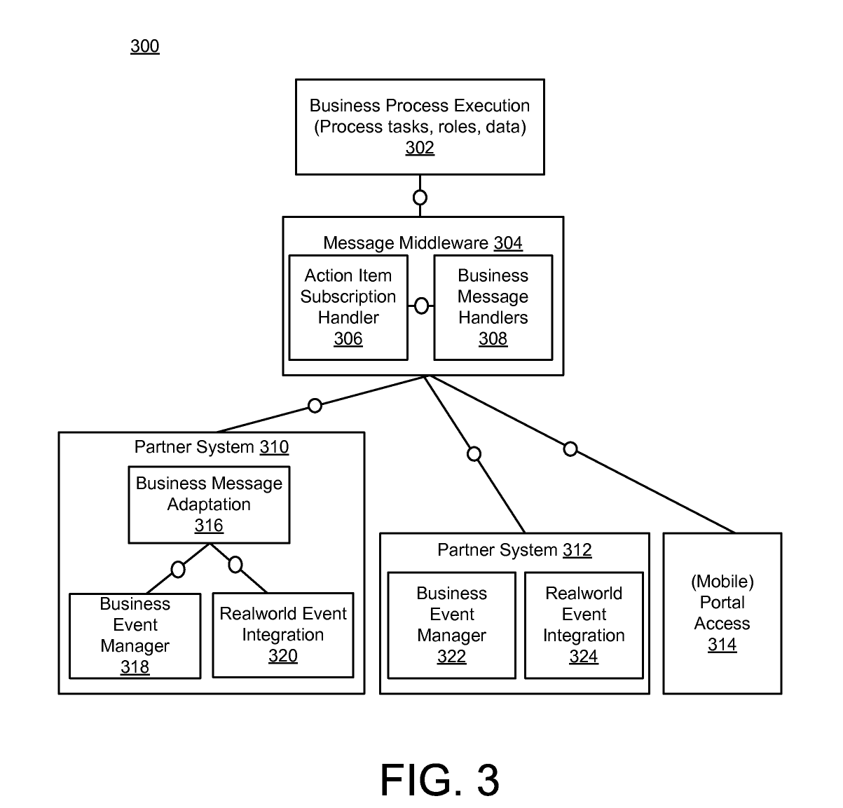

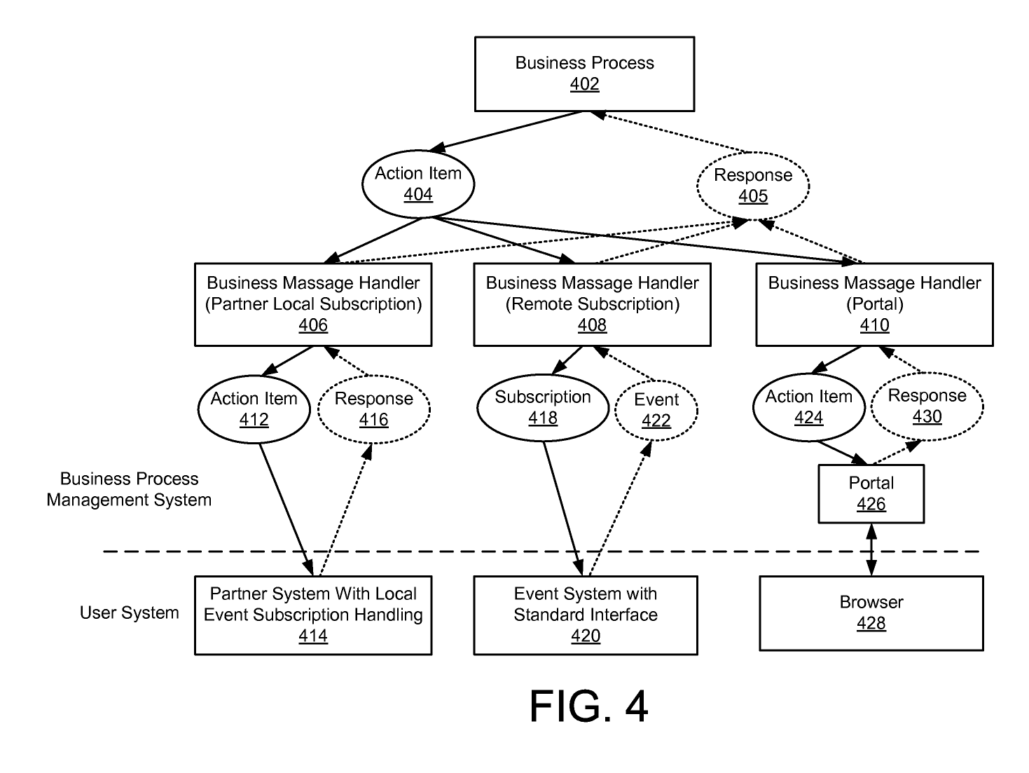

As also shown in the example of FIG. 1B, a communication manager 145 may be included within the message middleware 102. For example, in various implementations of the message middleware 102, the communication manager 145 may be configured to interact with the action item subscription handler 128 and the business message handlers 130 during runtime of a business process instance. In this way, the communication manager 145 may ensure proper delivery of action items to the correct business partner, as well as proper delivery of event notifications or responses from the business partner, including selecting and utilizing the correct communication channel corresponding to the selected business message handler and associated action item subscription. Examples of such communication channels would be apparent, and specific, non-limiting examples thereof are provided below, e.g., with respect to FIGS. 3 and 4.

In the example of FIG. 1B, the message middleware 102 is illustrated as being executed using at least one computing device 146. As shown, the at least one computing device 146 includes at least one semiconductor processor 148, as well as a non-transitory computer readable storage medium 150. Thus, for example, instructions for executing the various functionalities of the message middleware 102 described herein may be stored using the computer readable storage medium 150, and executed using the at least one semiconductor processor 148.

Of course, the illustration of the at least one computing device 146 of FIG. 1B is intended as a simplified illustration of the fact that the message middleware 102 transforms a general computing device into the special purpose computing device(s) of FIGS. 1A and 1B. Of course, such a transformation may be provided in various different contexts. For example, two or more components or subcomponents of the message middleware 102 in FIG. 1B may be executed using two or more computing devices in communication with one another, and/or may be executed using two or more semiconductor processors executing in parallel with one another. More generally, it will be appreciated that any individual component of FIG. 1B may be implemented using two or more subcomponents thereof. Conversely, but similarly, any two or more components or subcomponents of FIG. 1B may be combined for execution as a single component or module.

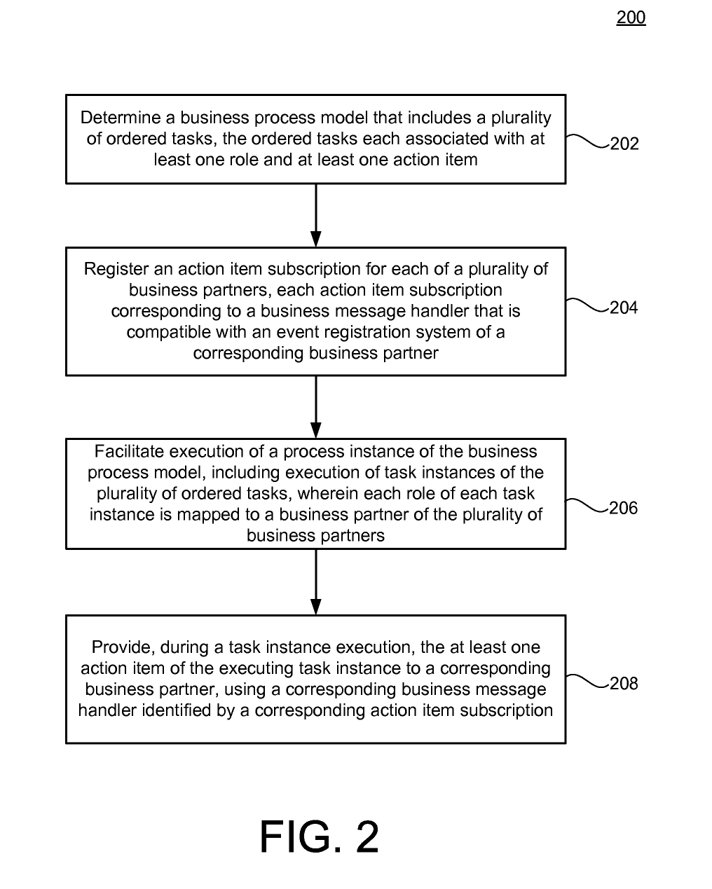

FIG. 2 is a flowchart 200 illustrating example operations of the systems of FIGS. 1A, 1B. In the example of FIG. 2, operations 202-208 are illustrated as separate, sequential operations. However, it may be appreciated that, in additional or alternative implementations, two or more of the operations 202-208 may be implemented in a partially or completely overlapping or parallel manner, or in a nested, iterative, looped, or branched fashion. Moreover, in various implementations, it may be appreciated that one or more of the operations 202-208 may be omitted and/or replaced, and/or that various other operations or sub-operations, not specifically illustrated in the simplified example of FIG. 2, may be included.

In the example of FIG. 2, a business process that includes a plurality of ordered tasks may be determined, where the ordered tasks are each associated with at least one role and at least one action item (202). That is, as described above with respect to FIGS. 1A, 1B, a business process may embodied in a business process model, such as the business process model 104, which includes one or more business process tasks. One or more roles may be assigned to the business process, where each role is expected to be mapped to a specific entity, e.g., a specific business partner, during execution of a process instance of the business process model. Each role may be associated with certain activities within the corresponding business process. Such a business process generally contains associated data, which may be provided and handled through actions by the various assigned roles. The business process tasks each may have certain event requirements which may expect to be informed about during execution of corresponding process instances, and expects to obtain information regarding such events through the issuance of action items to specific business partners, as described herein. In other words, each process task explicitly provides an interest in some event, which is represented as an event response of an identified business partner to a corresponding action item issued by the task instance.

In the context of FIG. 2, it is assumed that such a business process model, such as the business process model 104, may be defined using any conventional design techniques. In the context of such business process model design, it may be appreciated that the various functionalities of defining event requirements to be obtained through the issuance of action items, identification of one or more business partners for providing the desired event notifications or responses, and various other features and functions associated with the message middleware 102, as described herein, may be performed partially or completely. In other words, for various implementations of the message middleware 102, it may be possible to specify, at design time of a business process model, some or all of the associated business partners, action items, action item subscriptions, and associated business message handlers. In such cases, the business process model may be considered to be defined, for purpose of the message middleware 102, in a complete and final fashion, so that required action items, action item subscriptions, business partners, and associated business message handlers may be known at a time of deployment and execution of process instances of the business process model.

However, in many other implementations, it may occur that some or all of the tasks of the business process model may be implemented in a flexible, dynamic, or ad hoc manner. For example, in the logistics scenarios described herein, it is possible that a particular business partner to be used for a specific transportation segment is not known at a time of design or deployment of a given business process model. Additionally, or alternatively, it may occur that decisions made with respect to execution of a particular task of the business process model may not be made until completion of one or more previous tasks of the business process model. In such cases, it may not be feasible to completely configure or identify task completion parameters for all of the tasks of the business process model. Nonetheless, through the use of the message middleware 102, the systems of FIGS. 1A, 1B provide an ability to select and communicate with a desired business partner on the fly, using the available action item subscriptions and business message handlers, even when the task instance requiring the specified business partner is not defined as such until the time of commencement of execution of the task instance in question.

In order to obtain these and related features and advantages, an action item subscription may be registered for each of a plurality of business partners, each action subscription corresponding to a business message handler that is compatible with an event registration system of a corresponding business partner (204). For example, the action item subscription handler 128 of FIGS. 1A, 1B may be configured to receive, e.g., from each of the business partners 118, 120, 122, and via the action item subscription manager 132, an action item subscription specifying a business message handler of the business message handlers 130 required or desired by the business partner in question. As may be appreciated from the above discussion of the operation 202, such action item subscription registration may occur in conjunction with a definition or creation of the underlying business process model. In additional or alternative implementations, action item subscriptions may be registered after a time of creation and deployment of the particular business model. For example, even if a business process model was designed and deployed at some point in the past, it may nonetheless be possible to, e.g., add a new business partner with an associated action item subscription and business message handler preference, or to change an existing action item subscription for a previously-registered business partner.

Execution of a process instance of the business process model may be facilitated, including execution of task instances of the plurality of ordered tasks, wherein each role of each task instance is mapped to a business partner of the plurality of business partners (206). For example, the task instances 112, 114, 116 of a process instance of the business process model 104 may be executed. During execution of a given process instance and individual task instance, an associated role of the task instance may be mapped to a corresponding business partner of the business partners 118, 120, 122. For example, at the time of execution of the task instance 114, the role of shipment carrier may be mapped to the specific business partner 120.

During a task instance execution, the at least one action item of the executing task instance may be provided to a corresponding business partner, using a corresponding business message handler identified by a corresponding action item subscription of the corresponding business partner (208). For example, upon issuance of the action item 124, the action item subscription manager 132 of FIG. 1B may check the subscription repository 134 to determine that the business partner 118 is the intended recipient and prefers message handler 142 (portal handler) of the business message handlers 130.

In this way, the action item 124 may be routed to the business partner 118 in a manner required or preferred by the business partner 118, and may be provided quickly and efficiently, without requiring specific knowledge or action on the part of either the administrator of the message middleware 102 or the business partner 118 in order to ensure delivery of the action item as desired at a time of execution of the instance 112. Conversely, although similarly, and although not explicitly illustrated in the example of FIG. 2, it may be appreciated that the event response 126, sent in response to the action item 124 by the business partner 118, may similarly be routed by the action item subscription handler 128 to the same message handler (i.e., portal handler 142) previously identified with respect to the action item subscription of the business partner 118. In this way, again, the event response 126 may be provided back to the task instance 112 in a manner preferred or required by the task instance 112.

FIG. 3 is a block diagram of a system 300 illustrating a more detailed example implementation of the system 100A of FIG. 1A. In the example of FIG. 3, a business process execution 302 is illustrated which generally represents the types of process tasks, roles, and data described above. Similarly, message middleware 304 is illustrating as including an action item subscription handler 306 and business message handlers 308, which correspond generally to components of the same name (s) illustrated above with respect to FIGS. 1A, 1B. Thus, although the message middleware 304 may differ somewhat with respect to various implementation details as compared to the message middleware 102 of FIG. 1, the message middleware 304 may be understood to represent features and functions associated with the recognition that the business process execution 302 may require to be informed on various events taking place, e.g., with respect to partner systems 310, 312, 314.

As referenced above, such information may be provided using various techniques by the business partner in question, e.g., by interaction with a user at the business partner system via user interface, by way of enterprise systems (e.g., enterprise resource planning (ERP systems)), or from various sensor systems (e.g., RFID, or GPS). As described above with respect to FIGS. 1A, 1B, the system of FIG. 3 provides a separation of action item handling by the business process execution 302 and the various business partners 310-314, in order to provide a higher level of flexibility regarding partner interactions in the context of the business process execution 302.

As described, through the use of action item subscriptions associated with each of the partner systems 310, 312, 314, specific and appropriate business message handlers 130 may be assigned. Thus, the system 300 provides a decoupling of a signal that an event is needed (i.e., the action item) from the event registration exchange mechanism, i.e., the business message handlers 308, of the message middleware 304.

In the specific example of FIG. 3, the message middleware 304 may be understood to include at least three business message handlers 308, or, at least, may be understood to include at least one business message handler which includes, or is associated with, at least three different message handling execution techniques. That is, in the example of FIG. 3, it may be appreciated that at least one such message handling entity is available for each of the partner systems 310, 312, 314, as reflected in the corresponding action item subscription.

In the example, the business partner 314 utilizes a user interface, e.g., a portal, where a user of the business partner system 314 may access provided information (i.e., information provided by a corresponding action item from the message middleware 304), and react thereto using the same UI/portal. As may be appreciated, such techniques may be highly flexible and adaptable, and may easily be implemented in a variety of contexts (e.g., in the context of a mobile device). On the other hand, the use of the specific message exchange techniques may rely on human users to become aware of received action items, to obtain the desired event information, and to provide the event response back to the message middleware 304. For example, in the logistics domain as described above, the business partner 314 may provide a UI/portal that registers events in the manner described above. For example, the UI/portal may receive an action item requesting notification be provided in the event that a shipment is delayed. In such cases, the UI/portal enables registering of such an event by, e.g., creating an option on a webpage that an operator of the business partner system 314 may utilize to manually select an option indicating a delivery delay.

Meanwhile, with respect to the partner system 312, an example is illustrated in which real world/business event integration is provided using standard interfaces. For example, a business message handler of the business message handlers 308 may create an event registration via a standard interface in a real world event system of the business partner 312. For example, as referenced above, the business partner 312 may implement, or utilize, an event notification system implementing the EPCIS specification. For example, in the context of an automotive supply chain, event registration may be mapped through such a standardized EPCIS interface to a corresponding event repository. Of course, in other networks, additional or alternative forms of specific event registration techniques may be utilized.

In such examples, it is assumed that the partner system 312 receives an action item requesting notification of occurrence of one or more events or types of events. A real world event integration system 324, as referenced above, may detect the desired event, so that a business event manager 322 may provide a standard event message associated therewith to the message middleware 304. At the message middleware 304, the received event notification may be translated into an event response by the appropriate business message handler, and thereby forwarded to the business process execution 302 for further handling. In the example approach and with respect to the partner system 312, no specific components or event handling are required, aside from components specified by one or more related standards, so that the example of the partner system 312 represents a standard, easily integrated solution.

Finally, with respect to the partner system 310, as illustrated, a similar business event manager 318 and real world event integration 320 may be implemented. However, in the example of the partner system 310, user side message adaptation is provided. Specifically, a business message handler, appropriately selected by the action item subscription handler 306, may send a particular action item to the partner system 310 (or, in additional or alternative examples, the partner system 310 may pull the action items). Then, a business message adaptation 316 may receive an event from the real world integration 320 and the business event manager 318, and may be configured to transform the received event into a response to the received action item, for return thereof to the appropriate business message handler. The approach of the partner system 310 thereby requires users of the partner system 310 to specify parameters of the translation of received action items to event registrations, as well as the translation of events to action item responses, depending on the specific event management system of the business partner 310. The approach described with respect to the business partner 310 thus enables users thereof to connect virtually any backend system that provides required information, independently of standards supported by the business message handlers 308.

Thus by achieving the described separation of action items sent and event responses received, including integration of interaction capabilities and preferences of various business partners, users involved in a business process may interact in a preferred manner, and in a manner that is completely transparent to the business process itself. Furthermore, since users may be dynamically assigned to a business process (e.g., by starting a process themselves or being invited by a business partner), it is not necessary to have a fixed integration of users of the different business processes. Further, users are provided with an ability to change the setup of either an action item subscription and/or business message handler, as needed.

FIG. 4 is a block diagram illustrating more detailed examples of interactions that might occur in the example implementation of the system 300 of FIG. 3. In the example of FIG. 4, a business process 402, corresponding to the business process execution 302 of FIG. 3, it is illustrated as issuing an action item 404 and ultimately receiving an event response 405 in response thereto.

In a first example interaction, corresponding to the example of the partner system 310 discussed above with respect to the system 300 of FIG. 3, a partner system with local event subscription handling, i.e., partner system 414, is associated with a business message handler 406 which is identified as being compatible with the local event subscription handling of the partner system 414. Consequently, as described above with respect to the partner system 310 of FIG. 3, the business message handler 406 may simply forward the action item 404 as forwarded action item 412 to the partner system 414. As also described with respect to the partner system 310 of FIG. 3, subscription handling may occur locally to the partner system 414, so that a response 416 is provided by the partner system 414 in a manner which will be consistent and compatible with communication protocols and channels of the business process 402. Consequently, the business message handler 406 may forward the response 405 to the business process 402.

Meanwhile, an event system 420 with a standard event interface, corresponding generally to the partner system 312 of FIG. 3, may also be subscribed to receive the representative action item 404. However, in the example of the event system 420, it is assumed that a remote action item subscription (i.e., remote to the event system 420) is configured and managed using a business message handler 408. In this example, then, the business message handler 408 would be assumed to include the type of action item subscription handling described above with respect to FIGS. 1A, 1B. That is, for example, the action item 404 may be associated, using an action item subscription handler, with the event system 420, and with a configuration preference stored in association with the event system 420. In this way, the business message handler 408 may translate or otherwise mediate the exchange of the action item 404, so that a subscription 418 may be utilized to forward the contents of the action item 404 to the event system 420. Then, the event system 420 may simply utilize its associated standard interface to forward an event 422, which may thus be translated or otherwise mediated to provide the response 405 to the business process 402.

In a third example illustrated in FIG. 4, a browser 428 associated with the business partner, e.g., the business partner system 314 of FIG. 3, represents an example in which a human user of the relevant business partner reviews an appropriate user interface, i.e., the browser 428, to review action items received from the business process 402.

Thus, in the example, a business message handler 410 for mediating communication of the action item 404 with a portal is configured to provide the forwarded action item 424 to a portal 426. In this way, the human user of the browser 428 may view the forwarded action item 424 and related information, and may provide a response 430. The response 430 may thus be provided by way of the business message handler 410 as the response 405 to the business process 402.

In the present description, it may be appreciated that the described action items are capable of specifying relevant or necessary contextual information about a related process instance task, business data handled by the task instance, and responsible users assigned to handle information related to the action item in question. Such contextual information may be obtained from the business process itself, and may be utilized on one hand by the receiving system of the collaborating business partner, as well as by the relevant business message handler. For example, in the examples of logistics domains described herein, such contextual information may specify specific warehouse and shipment information for which the business process in question is expecting an event. Thus, the relevant business message handler may utilize such contextual information to return the event response of the collaborating business partner to the relevant business process instance.

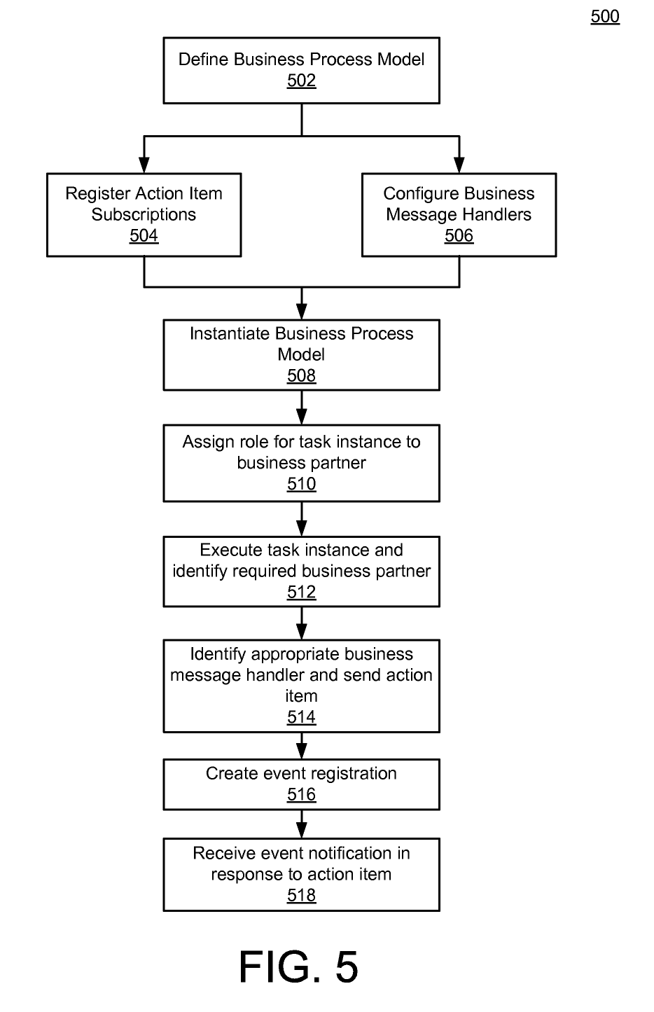

FIG. 5 is a flowchart 500 illustrating more detailed example operations of the systems of FIGS. 3 and 4. In the example of FIG. 5, a business process model is initially defined (502). During such business process definition, a general business process is modeled. Details of business process modeling and various contexts are well known, and are not described here in further detail. However, for the sake of providing a simplified and explanatory example, it may occur in the examples from the logistics domain described herein that a simplified logistics process may include the following business process tasks or steps: (1) submit and assignment for shipping goods, (2) invite a logistics service provider to organize the transport, (3) define the transport legs and invite carriers, (4) execute the different transport legs and inform the organizer about the beginning and completion of each transport leg, and (5) an associated billing process to collect payment for the shipment provided. However, in such examples, it may occur that the modeling of transport legs and the assignment of business partners or other users to the various roles of the defined business process model need not take place during the definition phase of the operation 502. Rather, as described, such modeling and assignment tasks may occur ad hoc during a later execution/runtime of the defined business process model.

Various action item subscriptions associated with corresponding business partners may be registered (504). Also, various business message handlers may be configured (506). For example, a number of business message handlers already may be available, and may simply be associated with a specific business partner, using a specific action item subscription. In other examples, it may be necessary to create a new business message handler to accommodate a desired action item subscription for a particular business partner.

In any case, it may be appreciated that the setup of action item subscriptions and configurations of business message handlers may occur independently of both process definition (operation 502), or process execution (operations 508-518). Rather, both tasks may be finished in order to ensure reliable delivery of action items to relevant business partners, so that valid configurations for individual business partners should be in place at a time when the executing business process needs to send the action item in question. Moreover, both action item subscriptions and business message handler configurations may be changed over time, as needed, such as when business partners are added or removed, or when an existing business partner wishes to modify existing configurations.

During a process execution phase of operations 508-518, the business process model is instantiated for an execution (508), and one or more roles for the current task instance may be assigned to a specific business partner (510). In other words, in the example of the logistics domain, concrete transport legs may be selected, so that appropriate business partners (e.g., shippers, carriers) are assigned to appropriate roles.

Thus, during execution of the task instance, the required business partner is identified (512). Assuming for the sake of the example that a business partner in question has a current action item subscription for receiving action items that require event-based responses, the appropriate business message handler specified for the business partner in question by the identified action item subscription may also be identified, so that the corresponding action item may be sent (514). As may be appreciated, the various example techniques for utilizing a given message handler to send the action item to the business partner are described above with respect to FIGS. 3 and 4.

Similarly, various techniques, some of which are described above with respect to FIGS. 3 and 4, may be utilized to create a requested event registration (516). In other words, the specified event or events may occur at, or be detected by, the identified business partner, and a notification or a response based on the event may be created and sent in response to the received action item (518). That is, again, as may be appreciated from the above description of FIGS. 3 and 4, the event notification/response may be forwarded using the previously identified business message handler.

In additional or alternative example implementations, an event registration may contain a unique business process identifier (ID) corresponding to the original process instance, such as a number or other identifier referencing the process instance. The event registration also may include the type or nature of the event being registered, as well as the individual task instance. As described, depending on the nature and configuration of the business message handler being used, the creation of the event registration may be handled in multiple ways.

For example, the relevant business message handler may create an event registration in the partner system by way of a specified standard interface, and thereafter wait for the required event, as described with respect to the event system 420 of FIG. 4 and the partner system 312 of FIG. 3. Then, such a business message handler may create an event response to the original action item, upon reception of the event by way of the standard interface. In other examples, as described with respect to the partner system 414 of FIG. 4 and the partner system 310 of FIG. 3, the relevant business message handler may forward the action item to the partner system in question, and the partner system itself may be responsible for creating the relevant event registration and ultimately returning an action item response to the business message handler upon occurrence of the specified event.

In this way, the overall business process instance may continue execution by moving on to a subsequent task instance. Thus, a collaborating process model may be deployed in a manner which flexibly, adaptively, and dynamically collaborates with a plurality of business partners, even when the various business partners have different communication infrastructures and preferences.

Implementations of the various techniques described herein may be implemented in digital electronic circuitry, or in computer hardware, firmware, software, or in combinations of them. Implementations may be implemented as a computer program product, i.e., a computer program tangibly embodied in a non-transitory information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A system including instructions recorded on a non-transitory computer-readable medium, and executable by at least one semiconductor processor, the system comprising:
a message middleware configured to cause the at least one semiconductor processor to determine a business process model that includes a plurality of ordered tasks, the ordered tasks each associated with at least one role and at least one action item, the message middleware including
an action item subscription handler configured to cause the at least one semiconductor processor to register an action item subscription for each of a plurality of business partners, each action item subscription corresponding to a business message handler that is compatible with an event registration system of a corresponding business partner;
a plurality of business message handlers configured to facilitate execution of a process instance of the business process model, including execution of task instances of the plurality of ordered tasks, wherein each role of each task instance is mapped to a business partner of the plurality of business partners; and
wherein the message middleware is further configured to cause the at least one semiconductor processor to provide, during a task instance execution, the at least one action item of the executing task instance to a corresponding business partner, using a corresponding business message handler identified by a corresponding action item subscription.

2. The system of claim 1, wherein the message middleware is further configured to cause the at least one semiconductor processor to receive, in response to the at least one sent action item and during the task instance execution, an event response from the corresponding business partner, using the corresponding business message handler specified by the corresponding action item subscription.

3. The system of claim 1, wherein the action item subscription handler comprises an action item subscription manager configured to provide an interface configured to receive configuration details for the action item subscriptions.

4. The system of claim 1, wherein the action item subscription handler comprises a subscription repository configured to store the action item subscriptions for the plurality of business partners.

5. The system of claim 2, wherein the plurality of business message handlers comprise:
a message handler configuration repository configured to store configurations of business message handlers.

6. The system of claim 5, wherein the plurality of business message handlers comprise:
a message handler execution manager configured to execute individual exchanges of the at least one action item and the event response for the corresponding action item subscription, using a corresponding configuration stored in the message handler configuration repository.

7. The system of claim 1, wherein the corresponding business message handler interfaces with a portal to provide notification to a user associated with the corresponding business partner by way of a user interface, and to receive an event response received from the user in response thereto.

8. The system of claim 1, wherein the corresponding business message handler communicates with a standard interface of an event system of the business partner.

9. The system of claim 1, wherein the corresponding business message handler interfaces with a business message adaptation of the business partner providing integration with a back-end event system of the business partner, to thereby provide the corresponding at least one action item and to receive an event response in response thereto.

10. A computer-implemented method for executing instructions stored on a non-transitory computer readable storage medium, the method comprising:
determining a business process model that includes a plurality of ordered tasks, the ordered tasks each associated with at least one role and at least one action item;
registering an action item subscription for each of a plurality of business partners, each action item subscription corresponding to a business message handler that is compatible with an event registration system of a corresponding business partner;
facilitating execution of a process instance of the business process model, including execution of task instances of the plurality of ordered tasks, wherein each role of each task instance is mapped to a business partner of the plurality of business partners; and
providing, during a task instance execution, the at least one action item of the executing task instance to a corresponding business partner, using a corresponding business message handler identified by a corresponding action item subscription.

11. The method of claim 10, further comprising receiving, in response to the at least one sent action item and during the task instance execution, an event response from the corresponding business partner, using the corresponding business message handler specified by the corresponding action item subscription.

12. The method of claim 10, wherein registering the action item subscription comprises providing a user interface configured to receive configuration details for the action item subscriptions.

13. The method of claim 10, wherein registering the action item subscription comprises storing the action item subscriptions in a subscription repository for the plurality of business partners.

14. A computer program product, the computer program product being tangibly embodied on a non-transitory computer-readable storage medium and comprising instructions that, when executed, are configured to:
determine a business process model that includes a plurality of ordered tasks, the ordered tasks each associated with at least one role and at least one action item;
register an action item subscription for each of a plurality of business partners, each action item subscription corresponding to a business message handler that is compatible with an event registration system of a corresponding business partner;
facilitate execution of a process instance of the business process model, including execution of task instances of the plurality of ordered tasks, wherein each role of each task instance is mapped to a business partner of the plurality of business partners; and
provide, during a task instance execution, the at least one action item of the executing task instance to a corresponding business partner, using a corresponding business message handler identified by a corresponding action item subscription.

15. The computer program product of claim 14, wherein the instructions, when executed, are further configured to cause the at least one processor to receive, in response to the at least one sent action item and during the task instance execution, an event response from the corresponding business partner, using the corresponding business message handler specified by the corresponding action item subscription.

16. The computer program product of claim 14, wherein the instructions, when executed, are further configured to cause the at least one processor to provide a user interface configured to receive configuration details for the action item subscriptions.

17. The computer program product of claim 14, wherein the instructions, when executed, are further configured to cause the at least one processor to store the action item subscriptions for the plurality of business partners in a subscription repository.

18. The computer program product of claim 14, wherein the instructions, when executed, are further configured to cause the at least one processor to store configurations of business message handlers in a message handler configuration repository.

19. The computer program product of claim 18, wherein the instructions, when executed, are further configured to cause the at least one processor to execute individual exchanges of the at least one action item and the event response for the corresponding action item subscription, using a corresponding configuration stored in the message handler configuration repository.

20. The computer program product of claim 14, wherein the corresponding business message handler communicates with a standard interface of an event system of the business partner.
